(19) United States
(12) Patent Application Publication
(10) Pub. No.: US 2005/0190382 A1
(43) Pub. Date: Sep. 1, 2005

(54) Method for suppressing blank pages in a multi-page scanning process and software therefor

(75) Inventor: Ron van Os, Morrison, CO (US)

Correspondence Address: Ron van Os, 8016 So Deer Creek Canyon Rd, Morrison, CO, 80465, US

(73) Assignee: Visioneer, Inc.

(21) Appl. No.: 10/787,912

(22) Filed: Feb. 26, 2004

(51) Int. Cl. G06F 15/00; G06F 17/24

(52) U.S. Cl. 358/1.1; 358/1.14

(57) ABSTRACT

The invention relates to a method for suppressing the display and printing of blank pages resulting from a set of scanned documents during a multi-page mode scanning operation. The inventive software determines, via algorithmic calculation, whether there is data sufficient on a page to result in a displayed or printed page of a document. The determination is achieved based upon pixel counts on the page. The invention reduces paper waste, data bit storage on a User's computer, and mitigates pagination issues in a hard copy scanned document.

### FIELD

The invention relates to a method for suppressing the display, printing, and data bit storage of blank pages resulting from a set of scanned documents during a multi-page or double-sided mode scanning operation.

### BACKGROUND OF THE INVENTION

The invention most closely corresponds with USPTO Class 358, wherein the invention provides for communication or reproduction of a static image or sequence of static images in which the local light, or density variations composing the image do not vary with time (e.g., a document image) by a method or apparatus.

In its simplest form, the invention comprises a software program relating to multi-page, or double sided scanning processes, wherein the inventive software program suppresses the blank pages of the multi-page scan, reducing data bit storage, eliminating blank page display in a final document, and eliminating blank pages in a printed document.

The multi-page scanning process as it exists prior to the invention does not eliminate the storage, display or printing of blank pages during a multi-page scan process. Not only does the inventive method suppress blank pages, thereby reducing data bit storage on a User's computer, it disallows printing of the same so as to achieve reduced paper waste and alleviates pagination issues.

### THE INVENTION

### SUMMARY, OBJECTS AND ADVANTAGES

The invention comprises in its broadest aspects, a new and unique method of utilizing a software program which performs calculations to determine and suppress the blank pages in a multi-page or double-sided scanning process, thereby eliminating paper waste, excess data storage, and resolving pagination issues.

The inventive software, once installed on a User's computer, allows the User to select from options to indicate that the scan is to be a multi-page, or double-sided scan, and to select an option to suppress blank pages within that scan. This is accomplished by a simple check box selection method as displayed on the inventive software's user interface as viewed on a computer screen.

The user interface, or dialog box, can also be initiated when a User depresses and holds the scanner's scan button similar to the feature in Applicant's own U.S. Pat. No. 6,480,304. The prolonged depression of the scanner button launches the same user interface as is displayed by the inventive software when commanded via the software menu.

In current multi-page scanning processes, all pages are scanned and blank pages are not only stored as data bits in a User's computer, the blank pages result as part of a final document as scanned to, or saved in a User's hard drive. Additionally, in the current state of the art, blank pages are printed in the final scanned document if a User has chosen to print the document. Not only does this cause a waste of paper, such scanned blank pages result in stored data bits which take up space on a User's hard drive. Further disadvantages of the current state of the art are that a blank page printed may then be numbered sequentially, and result in hard copy documents which have no data on them. By way of example, a ten page document may include three blank pages and render page numbering redundant.

Once a User has placed documents to be scanned in the scanner, and selected multi-page mode, the items are scanned as is typical to any optical scanning process. The inventive software executes an algorithm based upon detection of black and white pixel occurrence to determine whether a page is blank or has data thereupon. This determination is effected by the software calculating the total number of pixels on a scanned page, and differentiating between the number of white pixels, and the number of black pixels. Additionally, the inventive software factors for scans in both high and low resolution modes. The resulting conclusion of the software is a function of percentage. This percentage is defined by ratios as in the table example below:

| | Approx. total | | |
|---|---|---|---|
| 8.5 × 11 inch paper | pixels on page | Black pixels | Blank Page? |
| High resolution | 34,000,000 | 34 or less | Yes |
| Low resolution | 9,000,000 | 9 or less | Yes |

To further clarify the above table, the inventive software recognizes the number of pixels which are a set percentage type, i.e. 0.001% of the total pixels to determine if a page is blank. If, for example, the number of black pixels corresponds with an average number of 9 or less in a low resolution scan, or 34 or less in a high resolution scan, the page is determined by the inventive process to be blank.

The inventive software also accommodates grayscale scans. The process differs in function from black and white pixel counts only as to utilizing the average value of white pixels. The inventive software first optimizes the contrast and brightness of the original before converting it to bi-tonal, or black and white. Once the conversion is complete, the process of determining blank pages is performed as with the black and white pixel method. The User must select the grayscale option on the user interface as with any typical scan or print process.

The primary purpose of considering an average number of pixels is to suppress the blank pages in the scan while allowing for certain defects on a page. For clarification, a defect may be a hole punch or staple mark which would ordinarily cause the page to result in a scanned, stored, or printed page. The inventive software allows for the lower sigma gradation to compensate for the occurrences of defects on the scanned page, and will determine that a page with only staple marks or hole punch marks is to be suppressed in the final document.

### BRIEF DESCRIPTION OF THE DRAWINGS

The invention is described in further detail by reference to the drawings in which:

FIG. 1 is a screenshot example of the inventive software's user interface, or dialog box, as displayed on a User's computer screen;

FIG. 2 is a flow chart outlining the steps in process of the multi-page scan and suppression of blank pages;

FIG. 3 is a graph indicating the calculation scheme as used to determine whether a document is to be scanned to dark, i.e. page not suppressed; and

FIG. 4 which is a graph indicating the calculation scheme as used to determine whether a document is to be scanned to light, i.e. page suppressed.

### DETAILED DESCRIPTION, INCLUDING BEST MODES OF CARRYING OUT THE INVENTION

The following detailed description illustrates the invention by way of example, not by way of limitation of the principles of the invention. This description will clearly enable one skilled in the art to make and use the invention, and describes various embodiments, adaptations, variations, alternatives, and uses of the invention. The description includes what are presently believed to be the best modes of carrying out the invention.

In this regard, the invention is illustrated in four relatively simple figures; although sufficiently complex as to illuminate to one skilled in the art of such software architecture, programming, and computer operations a viable method for making or using said invention.

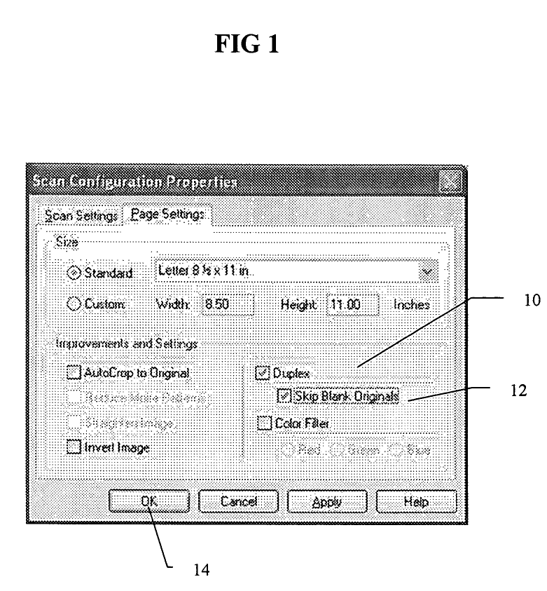

FIG. 1 shows a screenshot as displayed on a User's computer screen as a user interface, or dialog box. The User selects duplex or multi-page scanning mode by clicking on the checkbox 10. The User also selects skip blank originals 12 by clicking on the checkbox option. This selection indicates to the inventive software that it must perform the calculations to determine blank pages and suppress the same. Finally, the User selects OK 14 to begin the multi-page scan and subsequent blank page suppression.

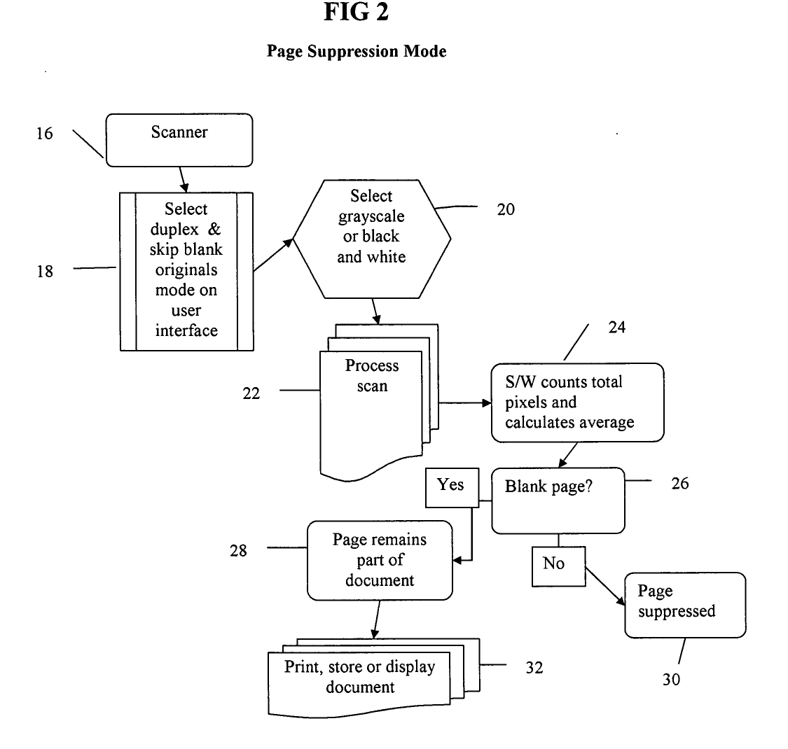

FIG. 2 is a flow chart depicting the process from insertion of pages to be scanned into a scanner, through the calculation and determination of blank pages, and finally to suppression thereof. In this process, a User inserts a document into a scanner 16 and launches the user interface as in FIG. 1. The User may then select 18 duplex and skip blank originals. Further, the User may select grayscale or black and white 20 as the mode for scanning. The document is scanned 22, and the inventive software then performs the calculations to determine the total count of pixels on a scanned page 24. Once such calculation is performed, the inventive software determines whether a page is blank 26, or has data thereupon.

If the page scanned is determined by the inventive software to contain data falling within the threshold for pixel count, and therefore contains data, the page remains part of the document to be stored or printed 28. If the page scanned is determined to be blank, or below the threshold for pixel counts, the page is suppressed 30 and will not be retained. Finally, the scanned document may be printed, stored or displayed 32 sans blank pages.

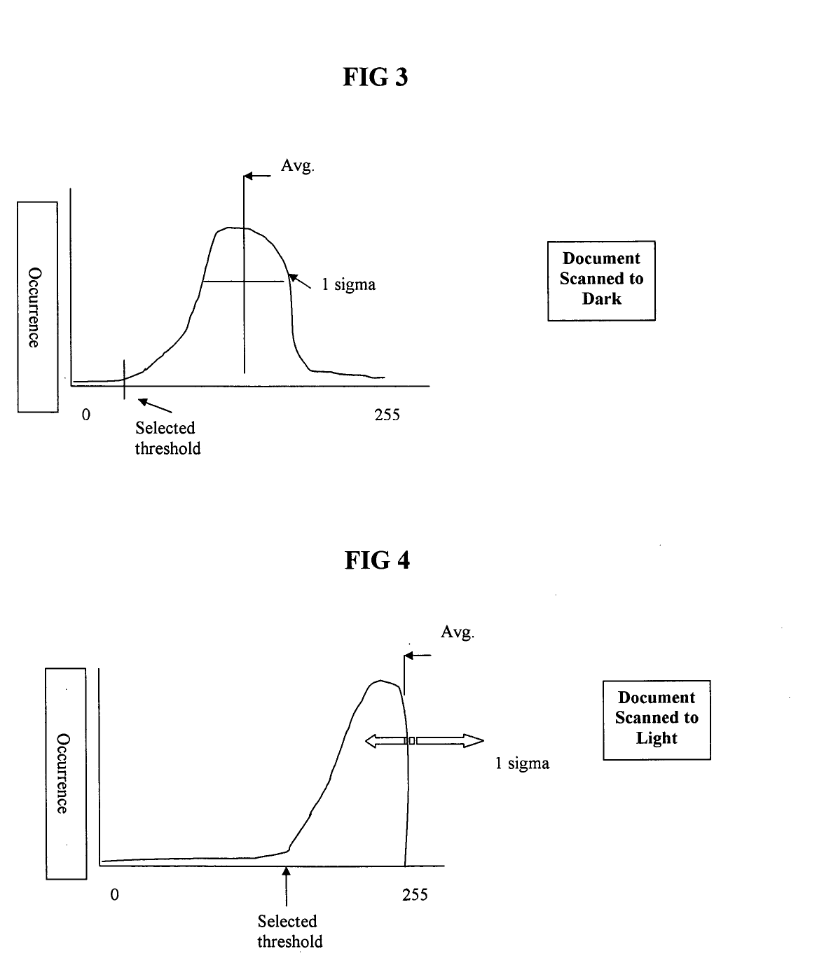

FIGS. 3 and 4 further clarify the flowchart of FIG. 2 in terms of defining the process by which page suppression is accomplished. FIG. 3 indicates the algorithm conducted by the inventive software to determine whether a page has data, and is therefore considered a “dark” scan. Once a page is optically processed in a scanner, the algorithm provides a range of numbers 34 which correspond to total pixel count on the page. A value is assigned to identify the average pixel count 36 as will determine the dividing point for light or dark pixels. The crosshatch 38 represents the sigma level, or percentage value from which to determine content to be suppressed or allowed in the final document. A selected threshold 40 has been predetermined by the inventive software and will serve as the breaking point for pixel count as residing below or above the 3 sigma value. If the scanned page is shown to have a pixel count at a percentage higher than 0.001% of the total count, the image is determined to be scanned as dark, or as containing content sufficient to remain as a valid page.

FIG. 4 represents a similar algorithm to that of FIG. 3. Again a numeric range corresponds to total pixels on a scanned page 42. After optically processing the page, an average number of pixels on the page is identified 44. If the pixel count is determined by the inventive software algorithm to be below the selected threshold 48, the page is determined to lack relevant content 46, and will be suppressed in the final document.

1) A method for computerized determination of blank pages and suppression thereof in a multi-page or double-sided scan process wherein computer program code determines page suppression and a user interface may be viewed on a computer screen.

2) A computer program as in claim 1 further comprising program code enabling creation and display of a user interface as will be displayed on a computer screen, comprising:
a) check box selection option allowing selection of duplex scanning mode;
b) check box selection option allowing selection to skip blank original pages in a multi-page scanning process;
c) check box selection option allowing selection of cropping, paper sizes, scan settings, and color filtering in a scanning process.

3) A computer program comprising program code capable of assessing a total number of black and white pixels on a scanned page.

4) A computer program as in claim 3 wherein the computer program performs an algorithmic process to differentiate between black and white pixels on a scanned page.

5) A computer program as in claim 4 wherein the computer program algorithm uses a set point for pixel determination comprising;
a) calculation of number of black pixels below a predetermined threshold number;
b) calculation of number of white pixels below a predetermined threshold number.

6) A computer program as in claim 5 wherein the computer program determines a scanned page as lacking data based upon the number of pixels below said threshold, and suppresses said blank page as relates to a final document.

7) A method for converting a grayscale scan into a bi-tonal image, comprising;
a) computer program code which converts a grayscale image to black and white;
b) computer program code enabling the page suppression scan process after conversion.

8) A computer program as in claim 2 wherein a final document is viewable on a computer screen in the form of a user interface displaying the final scanned documents with blank originals suppressed.
